(19) United States
(12) Patent Application Publication
(10) Pub. No.: US 2016/0096318 A1
(43) Pub. Date: Apr. 7, 2016

(54) THREE DIMENSIONAL (3D) PRINTER SYSTEM AND METHOD FOR PRINTING 3D OBJECTS WITH USER-DEFINED MATERIAL PARAMETERS

(71) Applicant: DISNEY ENTERPRISES, INC., BURBANK, CA (US)

(72) Inventors: BERND BICKEL, Zürich (CH); CHRISTIAN SCHUMACHER, Zürich (CH); STEVE MARSCHNER, Ithaca, NY (US)

(73) Assignee: DISNEY ENTERPRISES, INC., BURBANK, CA (US)

(21) Appl. No.: 14/505,827

(22) Filed: Oct. 3, 2014

(51) Int. Cl. B29C 67/00

(52) U.S. Cl. CPC B29C 67/0051; B29L 2009/00

(57) ABSTRACT

A 3D printer system that allows a 3D object to be printed such that each portion or object element is constructed or designed to have a user-defined or user-selected material parameter such as varying elastic deformation. The 3D printer system stores a library of microstructures or cells that are each defined and designed to provide the desired material parameter and that can be combined during 3D printing to provide a portion or element of a printed 3D object having the material parameter. For example, a toy or figurine is printed using differing microstructures in its arms than its body to allow the arms to have a first elasticity (or softness) that differs from that of the body that is printed with microstructures providing a second elasticity. The use of microstructures allows the 3D printer system to operate to alter the effective deformation behavior of 3D objects printed using single-material.

### BACKGROUND

1. Field of the Description

The present invention relates, in general, to fabrication of three dimensional (3D) objects, and, more particularly, to a 3D printer, and associated print method, adapted to print a 3D object of a digital model having one or more portions or object elements with user-defined material parameters such as elasticity or another physical characteristic such as electrical conductivity, optical characteristics, magnetic behavior, and the like. The user-defined material parameters may vary between the portions or object elements of the 3D object, even when printing with a single print or feed material, such as by having a first portion or object element being rigid (or non-elastic) and a second portion or object element being highly elastic or “soft” to the touch.

2. Relevant Background

Presently, 3D printing is a fabrication technology in which objects (or “printed 3D objects”) are created from a digital file, which may be generated from software such as a computer aided design (CAD) program or another 3D modeling program or may be generated using a 3D scanner to copy an existing object that provides input to a 3D modeling program. To prepare the digital file for printing, software that is provided on a printer-interfacing computer or running on the 3D printer itself slices or divides the 3D model into hundreds-to-thousands of horizontal layers.

When the prepared digital file of the 3D object is uploaded into the 3D printer, the 3D printer creates or prints the object layer-by-layer on a build plate or build platform. The 3D printer reads every slice (or 2D image) from the 3D model and proceeds to create the 3D object by laying down (or printing) successive layers of material on an upper, planar surface of the build plate until the entire object is created. Each of these layers can be seen as a thinly sliced horizontal cross section of the eventually completed or printed 3D object.

One of the more common 3D printer technologies uses fused deposition modeling (FDM) or, more generally, fused filament fabrication (FFF). FDM printers work by using a plastic filament (e.g., acrylonitrile butadiene styrene (ABS) or polylactic acid (PLA) provided as strands of filament) that is unwound from a spool mounted onto the printer housing. The plastic filament is used to supply material to a print head with an extrusion nozzle, e.g., a gear pulls the filament off the spool and into the extrusion nozzle. The extrusion nozzle is adapted to turn its flow on and off. The extrusion nozzle (or an upstream portion of the print head) is heated to melt the plastic filament as it is passed into the extrusion nozzle so that it liquefies. The extrusion nozzle deposits the liquefied material in ultra fine lines, e.g., in lines that are about 0.1 millimeters across.

The extrusion head and its outlet are moved, in both horizontal and vertical directions to complete or print each layer of the 3D model, by a numerically controlled mechanism that is operated by control software running on the 3D printer, e.g., a computer-aided manufacturing (CAM) software package adapted for use with the 3D printer. The build plate is typically stationary with its upper planar surface parallel to a horizontal plane (or horizontal to the nozzle or its printed layers). If the build plate is moved at all, it is only moved up and down vertically (i.e., in the z-direction). The extruded melted or liquefied material quickly solidifies to form a layer (and to seal together layers of the 3D object), and the extrusion nozzle is then moved vertically prior to starting the printing of the next layer. This process is repeated until all layers of the 3D object have been printed.

A significant limitation with existing 3D printing techniques is that the physical and other material properties of each printed 3D object are defined by the material used to print the 3D object. This can be very limiting as many additive 3D printing technologies can usually only use a single material. It may be desirable to print a 3D object that is elastic or “soft” in all or at least some of its elements. For example, it may be useful to provide a 3D printer user with control over the elastic properties of a 3D object to print out an object with spatially varying properties to produce components for soft robots, to print skins for robots and animatronic devices, and to prototype or produce a wide variety of elastic consumer products. However, most 3D printers such as FFM printers will typically produce a very rigid and hard object, e.g., a rigid outer shell with a honeycomb in-fill that is also structurally stiff.

Hence, it would be desirable to provide a 3D printing method, and associated 3D printer or printer system, that can print a 3D object with material parameters, such as physical or mechanical characteristics or traits, that can be user or operator-defined. Preferably, such a 3D printing method and 3D printer system could be implemented using existing 3D printers and/or 3D printer technologies including additive techniques like FFM including those that utilize only a single print material.

### SUMMARY

A 3D printer system, and print method carried out by the 3D printer system, is described that allows a 3D object to be printed such that each portion or object element is constructed or designed to have (or approximate) a user-defined or user-selected material parameter. For example, the material parameter may be elasticity or elastic behavior, with one goal of the inventors being to extend the range of reproducible elastic behavior of single material 3D printers. Specifically, the 3D printing method involves defining a library or database of microstructures or cells that are each designed to provide the desired material parameter and that can be combined during 3D printing to provide a portion or element of a printed 3D object having (or approximating) the material parameter.

In one exemplary prototype, a toy or figurine in the form of a 3D bear was printed using differing microstructures in its arms than its body to allow the arms to have a first elasticity (or softness) that differs from that of the body that is printed with microstructures providing a second elasticity. In this manner, the use of microstructures allows the 3D printer system to operate so as to alter the effective deformation behavior of 3D objects printed using single-material during 3D printing. By printing objects with one, two, or more material parameters, the 3D printer system is able to significantly extend the range of materials that can be reproduced or simulated in a 3D object, including materials that are rarely found or not found in nature such as materials with negative Poisson's ratios or other rare material parameters. By printing varying configurations or designs of microstructures or cells within a printed 3D object formed of a single print material, multi-material objects can be modeled without the need of multi-material printers.

Using a relatively stiff or non-elastic material, such as a plastic (e.g., acrylonitrile butadiene styrene (ABS), polylactic acid (PLA), or other material often used in 3D printers), the 3D printing method may involve designing or defining an assemblage of small scale microstructures that have the effect or characteristics of a softer or more elastic material (or other user-selected or user-defined material parameter) at the object scale. In other words, the 3D object or its portions/elements may have properties or characteristics depending on the microstructure used to print or additively form the 3D object or its portions/elements.

Numerical optimization(s) may be used to design microstructures that span a range of values of a material parameter such as a range of elasticity, electrical conductivity, or the like, and the library or database of the definitions of these different microstructures is stored in memory accessible to the printer control program (or other software module forming the digital file used to print the 3D object). The microstructures can then be combined or tiled to form a portion or object element of a modeled 3D object to provide a desired material parameter or property. During runtime, the print control program (or other software forming the digital print file) can synthesize the required microstructures for a specific object within seconds, and, in some cases, the 3D model with its microstructures can then be sliced or divided into numerous print layers to be sequentially printed layer-by-layer by a 3D printer.

More particularly, a system is provided for fabricating or printing a physical three dimensional (3D) object. The system includes a 3D print assembly adapted for additively forming the 3D object. For example, the 3D print assembly may include a fused filament fabrication (FFF) printer (or its print head, a build plate, and the head-positioning components). The system also includes a material supply providing print material to the 3D print assembly to form the 3D object (e.g., the material supply may be a spool of filament formed from a particular plastic material when the print assembly is an FFF printer).

The system also includes memory storing a plurality of definitions of microstructures (e.g., a library or database of possible microstructures). The system further includes a print controller running a control program, and the control program operates the 3D print assembly to form the 3D object based on a print file defining object elements of the 3D object. The object elements are formed by fabricating a plurality of the microstructures, and this may involve printing one object element (e.g., a figurine's arm) using a first microstructure and another object element (e.g., the figurine's head) using a second microstructure) to achieve differing ranges of values for a particular material parameter.

Particularly, in some implementations of the system, each of the microstructures is associated with a range of values for a material parameter. In one particular case, the material parameter is elastic deformation while others may define electrical conductivity, optical characteristics, magnetic properties, and/or other physical or chemical parameters of a material. The range of values of a material parameter will vary based on the print material, and, hence, the range of values is defined for the print material provided by the material supply.

In some systems, the control program generates the print file from a 3D model (e.g., a digital file from a user of the printer system) including a first material parameter definition for a first region and a second material parameter definition for a second region. Then, the control program generates the print file to include a first one of the microstructures in the first region and a second one of the microstructures in the second region, whereby material parameters vary for the object elements of the formed 3D object. In other words, the control program acts to select particular microstructures for use in printing a 3D object to provide particular ranges of material parameters in differing regions (which may be a part of an object element, a whole object element, or more than one object element).

The first region and the second region may mate or join at a boundary, and the control program selects the first and second ones of the microstructures to have compatible outer structures to bind together adjacent ones of the microstructures in the 3D object. In other words, more than one microstructure in the library may be suited to provide the range of parameter values, but the microstructures preferably have geometries that allow them to be printed next to each other with mating or adjoining outer surfaces.

In some cases, the method synthesizing microstructures may utilize a library of predefined microstructures. Then, the method may involve using these one or more of these microstructures to print an object element or region of a 3D object. Hence, the predefined “microstructure” used to form the 3D object's elements or regions can be a combination of microstructures from the library. In other words, it should be understood that the term the term “predefined microstructures” as identified (or generated for printing a 3D object as part of the printing method) may be construed to mean “predefined microstructures (from the library, for example) and combinations thereof.”

### BRIEF DESCRIPTION OF THE DRAWINGS

FIG. 1 is a functional block diagram of a 3D printer system configured for printing 3D objects using microstructures or cells;

FIG. 2 is a front view of a digital model of the 3D object being printed in the system of FIG. 1 showing an example of how the digital model may be displayed in a user interface to allow a user/operator to select material parameters or characteristics for object elements or regions and to assign values or value ranges of the material parameter to each object element or region;

FIG. 3 is a front view, similar to FIG. 2, showing in schematic fashion (or functional block-type manner) the 3D object being printed with the system of FIG. 1 and the use of three different microstructure configurations in three regions or object elements to provide three different values or ranges of values for a material parameter in a printed 3D object;

FIG. 4 is a flow diagram of a 3D printing method as may be carried out by the operation of the system of FIG. 1;

FIG. 5 is flow diagram or schematic providing an overview of the 3D printing process including the pre-processing and synthesis stages as may be carried out during operation of the system of FIG. 1;

FIG. 6 illustrates, in 2D, harmonic displacements of an exemplary microstructure base cell;

FIGS. 7 and 8 illustrate different stages of optimization of a cell;

FIG. 9 illustrates graphically results of an exemplary interpolation between two microstructures;

FIG. 10 illustrates graphically results 1010, 1020, 1030, and 1040 of the smoothing pass for different Gaussian spread values;

FIG. 11 illustrates a graph presenting data points for three data points for three different parameter space for a cubic material in 2D;

FIG. 12 illustrates three potential configurations of neighboring cells or microstructures;

FIG. 13 illustrates a starting initial structure and microstructures generated without similarity regularization and with similarity regularization;

FIG. 14 illustrates three graphs providing the individual spaces for the structures shown in FIG. 11; and

FIG. 15 illustrates a graph showing the Poisson's Ratio and Young's Modulus for an exemplary set of microstructures and perspective views of the microstructures.

### DETAILED DESCRIPTION

With the emergence of affordable 3D printing hardware and online 3D printing services, additive manufacturing technology comes with the promise to make the creation of complex functional physical artifacts as easy as providing a virtual description of an artifact or 3D object. However, many functional objects in our everyday life as well as virtual models provided with computer graphics are formed with a design or of differing materials such that these objects may have a variety of material properties or parameters. For example, many of these objects are formed of an elastic and deformable material. Unfortunately, elastic properties and other material parameters such as varying electric conductivity or magnetic characteristics are not easy to provide with existing 3D printer technology as most 3D printers can only use a single material or a very small set of materials, which often do not provide a match for the desired values of material parameters (e.g., a higher elastic deformation behavior).

The inventors recognized, though, that 3D printing can be used to create complex, high-resolution 3D structures, which can successfully be used to create metamaterials with properties that were previously unachievable with 3D printers. The 3D structures are labeled microstructures or cells herein and can be used to provide regions of a 3D object or object elements of a 3D object that behave as if they were formed of a material that provides a value or range of values of a material parameter (e.g., an object element may be assigned a particular elasticity value or a range of values (e.g., soft, medium soft, hard, and so on when the material parameter is elastic deformation or elasticity)). Metamaterials are assemblies of small scale structures (i.e., microstructures or cells) that obtain their bulk properties from the shape and arrangement of the microstructures or cells rather than from the composition of the material used to print or otherwise form the microstructures or cells.

Briefly, with this in mind, a 3D printing system and associated methods are described for fabricating deformable objects (or objects with one or more other material parameters) with spatially varying elasticity. Using a relatively stiff printer material (e.g., a plastic or metal often used as supply material (e.g., filament) for 3D printers), the printing method involves designing an assemblage of small-scale microstructures or cells that when printed together (such as with an FFM-type 3D printer or other additive technology printer) have the effect (have a value or range of values of a material parameter) of a softer material at the object scale, with properties depending on the particular microstructure used in each region, portion, or element of the printed 3D object.

In some implementations, the 3D printer system may build upon work in the area of metamaterials, using numerical optimization to design tiled microstructures with desired properties, but one key difference being that the described 3D print method (implemented in or with the 3D printer system) designs families of related microstructures that can be interpolated to smoothly vary the material properties (or values of a particular material parameter) over a wide range. To create a 3D object with spatially-varying elastic properties (or another material parameter), the printing method may involve tiling the 3D object's interior or a region or object element of the 3D object with microstructures drawn from this family (or library or database of previously generated or defined microstructures useful for providing a range or a value for a material property such as a range or value of elastic deformation). A different microstructure or microstructure design may be used for each object element or region of a 3D object (e.g., to achieve differing values or ranges of values for a particular material parameter or physical property), and an algorithm may be used to select compatible microstructures for neighboring object elements or regions so as to ensure the microstructures in a transition or mating region between the neighboring object elements or regions can be printed or formed to have mating or bonding structural features.

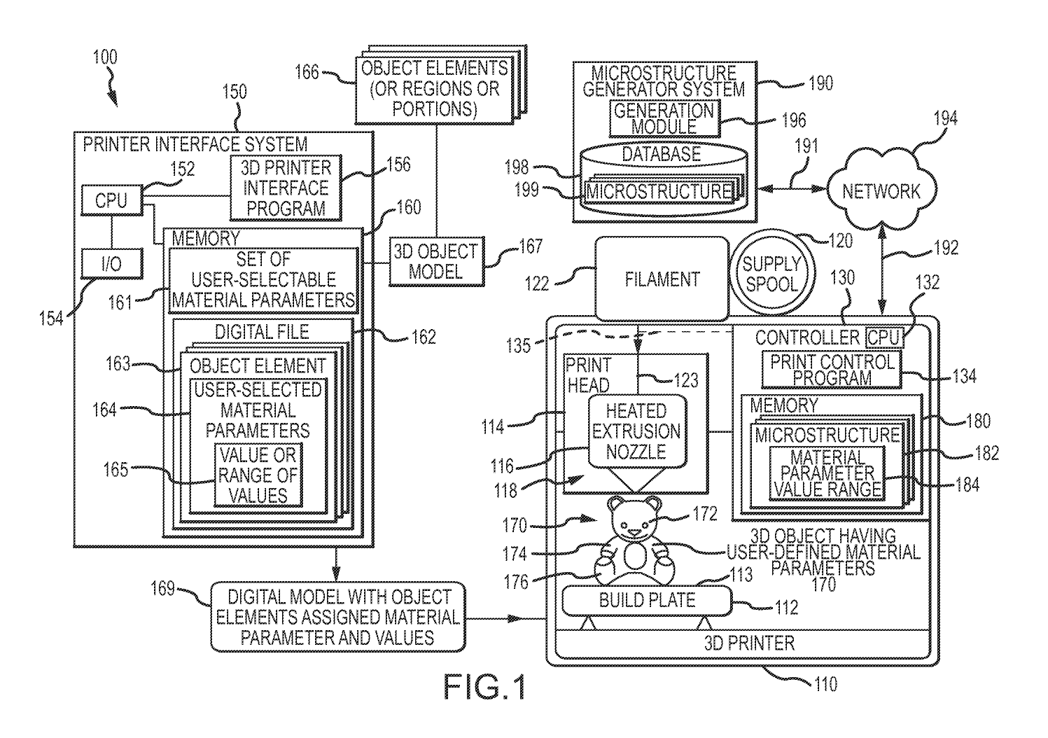

FIG. 1 illustrates a functional block diagram of a 3D printer system 100 configured for printing 3D objects (such as 3D object 170) using microstructures or cells to define the material parameters or characteristics of the object elements or regions 172, 174, 176. As shown, the system 100 includes a 3D printer 110, a printer interface system 150, and microstructure generator (or server) system 190. The printer interface system 150 may be a desktop computer, a workstation, a laptop or pad computer, or other computer device operable by a user of the 3D printer 110 to select (or generate) and transmit a digital model 169 to the 3D printer 110 for use in printing a 3D object 170. To this end, the printer interface system 150 includes a processor or central processing unit (CPU) 152 that operates or manages input and output (I/O) devices 154 such as a monitor, a touchscreen, a mouse, a keyboard, speakers, voice recognition devices, and the like that allow an operator or user of the system 150 to provide user input such as via a graphical user interface (GUI) generated and displayed by the 3D printer interface program 156.

Particularly, the printer interface system 150 may include memory devices or data storage components (e.g., computer readable medium) 160 (or have access to such memory devices) that are managed by the processor 152 to store one or more digital files 162 that are used to print a 3D object 170. Also, the system 150 may use the CPU 152 to execute code or software (in computer readable medium such as RAM, ROM, or the like on the system 150) in the form of a 3D printer interface program 156. The interface program 156 may be downloaded onto the system 150 to allow an operator to interact with the 3D printer 110 and its print controller 130, and the 3D printer 110 may provide this software/program 156 upon a first link of the system 150 and the 3D printer 110 or the software/program 156 may be downloaded separately (e.g., by inserting a CD into the system 150, by accessing a web site associated with the 3D printer 110, or the like).

In practice, the 3D printer interface program 156 may be adapted to cause a series of interface screens to be presented by the system 150 and the I/O devices 154 to a user. The user may select a 3D object for printing by first generating a 3D model 167 of a 3D object (or the user may retrieve a file defining the 3D model 167 or an existing 3D object may be scanned to provide the model 167). The 3D object model 167 may include a plurality of object elements, regions, or portions 166 (e.g., legs, arms, a body, and a head if the object 167 is a figurine, a fuselage and wings if the object 167 is an airplane, a trunk and branches if the object 167 is a tree, and so on). In other cases, the object elements, regions, or portions 166 may be designated or selected by the user such as via a GUI provided on the I/O devices 154 (e.g., the user may draw boundaries between two or more regions on the 3D object model 167 to define the size, shape, and location of the object elements or regions 166 in the 3D object 167).

The 3D printer system 100 is configured to allow a user to select material parameters or properties that they wish to set or control for a 3D object 170 printed using the 3D object model 167. Further, the user is able to use to select or define values or ranges of values for the selected material parameters or properties. To this end, the memory 160 may be used to store a digital file 162 generated from the 3D object model 167 with object elements 163 associated with the elements or regions 166 (which may be set by the 3D printer interface program 156 or be defined by the user).

The memory 160 may be used to store a set of user-selectable material parameters 161, which can be displayed in a GUI on an I/O device 154 for selection. The material parameters 161 may vary to practice the system 100 but may include elastic deformation (or elasticity), optical properties, electrical properties (e.g., electrical conductivity), magnetic properties, physical characteristics of an object often set or varied with material forming the object, and so on. The material parameters 161 are limited only by the microstructures 199 that have been designed and generated to provide values or ranges of values of various material parameters (e.g., microstructures 199 in a database or library 198 configured provide elasticity over a wide range, to provide varying electrical conductivity, to provide differing optical qualities, and so on). As shown in FIG. 1, the user may select a material parameter 164 (from the set of parameters 161) for which they want to set or define values for each object element or region 163 of the 3D object model defined in the digital file 162.

In addition, the user may use a default value (or range of values) for the selected material parameter 163 as the value (or range of values) 165 to be provided in an object 170 printed using file 162 or the user may select from one of a plurality of values or ranges defined for that material parameter 163. For example, each of the set of user-selectable material parameters 161 may have a number of values or ranges of values that the user may select. The user may be able to actually select a value (or range of values) for a variable that defines (at least in part) that material parameter such to set Poisson's Ratio or Young's Module when elasticity is the material parameter. More typically, though, the user will select a value for the parameter at a higher level such as to select soft to indicate a readily deformable region of an object when elasticity is the material parameter, substantially transparent when optical qualities is the material parameter, resistive or highly conductive when electrical conductivity is the material parameter, and so on.

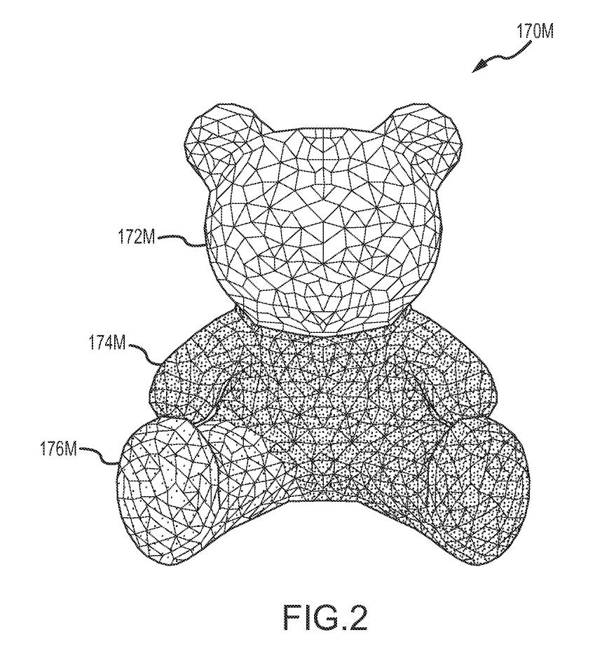

FIG. 2 illustrates an image 170M of the 3D object model 167 (with “M” indicating model) that may be displayed upon a monitor 154 in a GUI provided by the program 156. A user may interact with the image 170M to select a material parameter to adjust for each region or object element of the image 170M (and model 167). In this simplistic example, the user has chosen to assign a material parameter (such as elasticity or elastic deformation) for three regions or object elements 172M, 174M, and 176M (e.g., a bear's head, a bear's arm (or body), and a bear's leg in this example). The user may be able to assign a numerical value or value range for each of these regions 172M, 174M, 176M such as from a set of such values or value ranges displayed by the program 156 in the GUI showing the image 170M. In some cases, the user may be able to paint or color the differing regions 172M, 174M, 176M to assign material parameter values (and, in some cases, to define the regions' boundaries) such as with blue being stiff (or non or less elastic), red being soft (or very elastic), and green being a medium stiffness or softness).

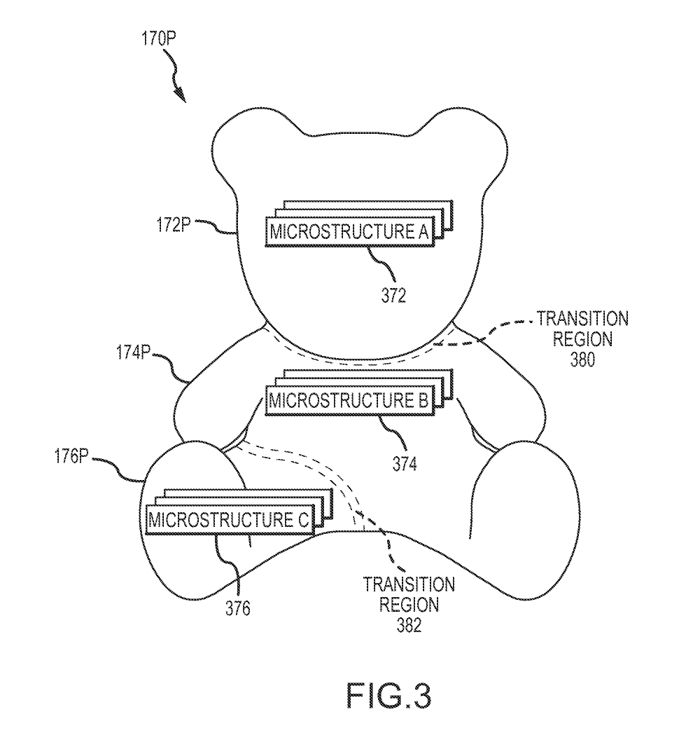

Once the material parameter 164 and its value or range of values 165 is set for each object element or region 163, the digital file 162 may be processed by the print controller 130 for use in printing the 3D object 170. FIG. 3 illustrates in functional block or schematic fashion the printed 3D object 170P (with “P” indicating printed version of the object). As shown, the printed object 170P was printed to provide a first value of a material parameter in the head or first region/object element 172P by printing its layers to provide a tiling of numerous microstructures 372. Likewise, the printed object 170P was printed to provide a second value of a material parameter in the arm/body or second region/object element 174P by printing its layers to provide a tiling of numerous microstructures 374. Further, the printed object 170P was printed to provide a third value of a material parameter in the leg or third region/object element 176P by printing its layers to provide a tiling of microstructures 376.

The material properties may be the same or differ in each region 172P, 174P, and 176P, and the value or range of values may be the same or differ in each region 172P, 174P, and 176P. When the value or range or material properties differ, the microstructures 372, 374, and 376 typically will differ in their configurations from each other. As explained below, the microstructures of printed object 170P are chosen (such as by the print control program 134) to be compatible so as to allow forming of transition regions 380, 382 between the regions/object elements (between 172P and 174P and between 174P and 176P, respectively).

Referring again to FIG. 1, during operation of the system 100, the printer interface system 150 functions to communicate (wirelessly or in a wired manner) with the 3D printer 110 including transmitting a digital model 169 (or sending the digital file 162) to the 3D printer 110 for use by the print control program 134 to print a 3D object 170 (in other cases, the print control program 134 accesses the digital file 162 in the memory 160, as needed for printing, rather than transmitting the model 169 to the 3D printer). The 3D printer 110 includes a build plate or print bed 112 with an upper or exposed planar surface 113 upon which melted plastic is printed from a print head 114 to form a 3D object 170 including its different regions/object elements 172, 174, 176 (with the same or differing microstructures in each region to provide a desired value/range of values for the same or differing material parameters).

The 3D printer 110 includes a print head 114 with a heated extrusion nozzle 116 with a pointed tip/outlet 118 from which liquid plastic is ejected or extruded to build up the object 170 layer-by-layer (including the regions 172, 174, 176 and the microstructures used to form these portions or parts of the object 170). In some cases, the heated extrusion nozzle 116 may include a heater or heat coil about a tube while in other cases a heated chamber is provided immediately upstream of the tip/outlet 118 to liquefy or melt plastic to prior to extrusion. Further, the 3D printer 110 includes a print material supply in the form of a supply spool 120 upon which is wrapped or wound a length of plastic that can be drawn as shown by arrow 123 into the extrusion nozzle 116 where it is melted or liquefied by a heater. For example, the filament 122 may take the form of ABS, PLA, or other plastic, a metal, or other material useful in 3D printing, and, even though a single material (or limited number of materials) is provided by filament 122, the printer 110 is able to print a 3D object 170 having differing material properties or parameters in each region/element 172, 174, 176 through the use of the microstructures described herein.

The 3D printer 110 includes a controller 130 for interfacing with the printer interface system 150 so as to print a 3D object 170 based on the digital file 162. The controller 130 includes a processor 132 executing or running software/code in the form of a print control program 134 (e.g., code in computer readable media accessible by the CPU 132). The print control program 134 is configured to selectively cause the filament 122 to be drawn (e.g., with gearing or the like) 123 from the spool 120 into the head 114 while also operating to move the print head 114 and/or build plate 112 within a layer and to a new layer to print the 3D object 170 (e.g., to provide 3D printing, layer-by-layer as is known by those skilled in the art of 3D printing).

The system 100 further includes a microstructure generator (or server) system 190 linked as shown by wired or wireless communication links 191, 192 with the print controller 130 via the network (e.g., the Internet or the like). The generator system 190 may be a computer system (as described fro system 150) that executes code or programs in the form of a generation module 196 to function to create and serve a library or database 198 of microstructures 199 (which may be stored in data storage or memory of the system 190). The microstructures 199 may each be configured to provide, when combined with or tiled with in a printed region or portion of a 3D object, a value or value within a range of values of one or more material parameters. The generation of the microstructures by the module 194 (or by other software and/or algorithms) is described below in greater detail.

The generator system 190 serves or transmits the library or database 198 of the microstructure definitions 199 to the printer controller 130, which stores a copy of the microstructure definitions in a memory device 180 as shown at 182. A material parameter and its value or range of values provided by the microstructure may be associated with each structure 182 as shown at 184, which allows the print control program 134 to quickly retrieve one, two, or more of the microstructures 182 as needed to produce a particular object element or region 163 in a user-provided digital file 162.

More particularly, the print control program 134 may receive the digital file 162 and, prior to slicing the model into a plurality of print layers, process the object elements/regions 163 to determine which material parameter(s) 164 has its values defined (as shown at 165). The print control program 134 may retrieve one or more microstructures 182 for each of the object elements 163 that will produce or provide the user-defined or selected value (or range of values) 165. Then, an algorithm may be run (as discussed below) to choose among these matching microstructures to ensure compatibility at the transition regions or areas between the object elements 163 (e.g., to ensure that material of boundary microstructures is available to support and/or to bind with other boundary microstructures). Once microstructures are selected for each object element/region 163 to provide a desired material parameter value (or range of values), the print control program 134 may operate (or use its slicer routine) to divide or slice the model defined in the file 163 into print layers or slices, including printing the microstructures in each region/object element layer-by-layer. This print control file is then used by the control program to operate the printer 110 to print the 3D object 170 (with the microstructures as discussed with reference to FIG. 3).

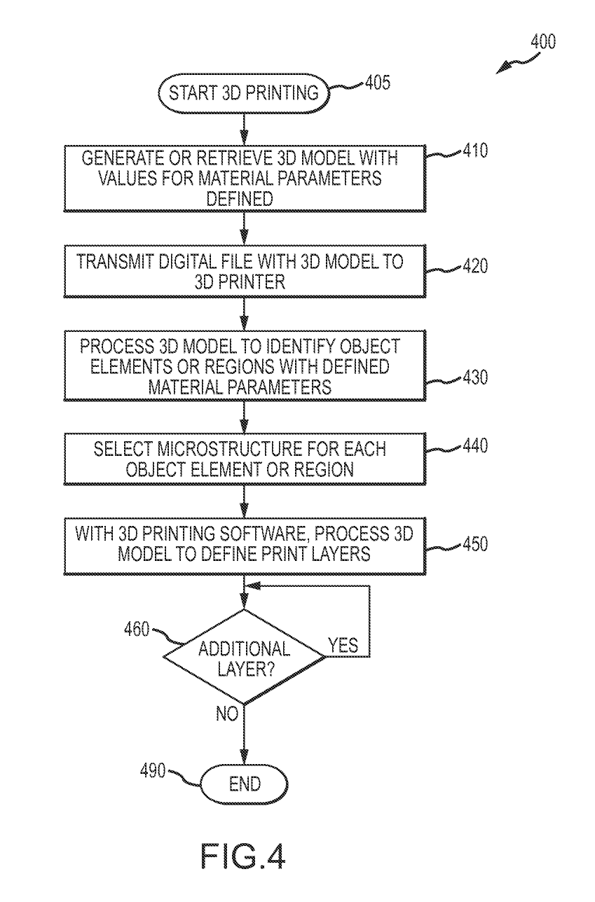

FIG. 4 illustrates a 3D printing method 400 that may be performed according to the present description such as by operation of the system 100 of FIG. 1 or another 3D printer. The method 400 starts at 405 such as with communicatively linking a printer interface system/computer with a 3D printer and loading a library or database of microstructure definitions (e.g., 3D models of each possible microstructure).

At 410, the method 400 includes generating or retrieving a 3D model of the target object, which may involve generating the digital file 162 with the printer interface system 150 of FIG. 1 as discussed above so as to include at least one object element or region having a value or range of values for a material parameter defined by the user (e.g., a range of values of elastic deformation for a portion of the modeled 3D object). The method 400 then continues at 420 with transmitting a digital file defining this 3D model, such as file 169, to a 3D printer, such as printer 110, for use in printing a 3D object.

At step 430, the method 400 continues with processing the 3D model to identify each of the regions or object elements for which a value of a material parameter has been defined. Then, at 440, the method 400 involves selecting a microstructure for use in each of the regions identified in step 430. As discussed above, the microstructure selection is performed to ensure compatibility of neighboring regions or object elements being printed to be made up of tiled microstructures, and the microstructure selection performed in step 440 is described in greater detail in the following paragraphs.

At step 450, the method 400 continues with using 3D print control software (such as program 134) to process the 3D model to define the print layers (or slices). This step 450 may involve using a slicer or similar program to define a plurality of thin slices of the model to print sequentially with a 3D printer (such as an FFM printer) or layer-by-layer. Each layer includes a number of print locations (or voxels that may correspond with X-Y coordinates) where the 3D printer will be used (and positioned) to deposit a volume of liquid plastic to form the layer, and a plurality of layers is used to print each microstructure (e.g., each microstructure has a predefined thickness, which is typically as small as practical to provide the desired material parameter value or range of values). The method 400 continues at 460 with a determination of whether there are additional layers to process. If yes, the method 400 continues at 460 with printing at a next print location. If no additional layers, the method 400 ends at 490 with the 3D object including regions or object elements having user-defined/selected material properties or parameters being produced in an additive manner to form numerous microstructures in at least one region or object element.

At this point in the description, it may be useful to provide a further discussion of the difficulties presented in generating the microstructures that when combined or tiled in large numbers can provide differing material parameters such as differing physical properties. Then, the discussion will turn to exemplary techniques that the inventors have used to address these difficulties or challenges to generate microstructures or cells for use in 3D printing.

Approximating a desired elastic deformation behavior (as one example of a material parameter or physical property) with metamaterials or groups of metastructures is highly challenging. This approximation may be thought of as a complex inverse problem involving determining a discrete small-scale material distribution at the voxel resolution of a 3D printer that yields the desired macroscopic elastic behavior (or other desired material parameter value or behavior). Inverse problems of this type have been explored for designing periodic structures, but the methods have generally been very computation intensive to implement. For example, state-of-the-art approaches have reported computation times on the order of 10 hours using many processors (e.g., one implementation used 120 CPUs) for problems of 100³ voxels. While some of these structures could be tiled for homogenous volumes, approximating the material behavior of heterogeneous objects, such as object 170 shown in FIGS. 1-3, is much more computationally costly. Hence, as modern 3D printers are operating in resolutions of up to 10⁸ voxels per cubic inch, a different computational approach is required.

One of the goals of the inventors in developing the 3D printer system and method described herein is to enable users to employ metamaterials in their 3D printing workflow by generating and/or selecting appropriate microstructures specifically for their available 3D printer model and, in some cases, a particular base material within seconds (e.g., each microstructure may have associated with it a value or range of values for a particular material parameter for each printer material that is expected to be used with a particular 3D printer). The inventors recognized that designing microstructures on the fly using a direct optimization algorithm is most likely impractical. Instead, the inventors propose and teach a data-driven approach that efficiently synthesizes small-scale structures (or microstructures) that: (1) provide (or at least resemble or approximate) the user-defined or desired local elasticity (or other value of a material parameter defined by the user for a local portion of a 3D object); and (2) are suited for 3D printing and within the gamut of the output device (e.g., for 3D printers presently available and likely available in the coming months and years).

In brief, a database or library of microstructures is precomputed (i.e., computed prior to creating a printer model of a 3D object). The values or ranges of values of a particular material parameter for the microstructure for each print material is stored in a data storage device (e.g., elastic properties of each microstructure is stored for each type of print material). It is desirable for these microstructures to have values or properties that cover a relatively large and, ideally, continuous region in the space of possible material parameter behaviors (e.g., large range of possible elastic behaviors). To achieve this goal, an optimization method can be used for sampling microstructures that match a desired behavior and that are also sufficiently similar to allow interpolation.

In practice, it was observed that the same elastic behavior (or other parameter behavior) can be reproduced by a plurality of microstructures that can significantly differ in shape (or geometric design). Therefore, a one-to-many mapping of elasticity parameters (or other parameters) to metamaterial microstructures is preferably established. To synthesize the metamaterials for a specific object, the object elements or regions (e.g., the object's interior space or volume) are tiled or filled with microstructures drawn from the library or database (e.g., from the one-to-many mapping), which provides a set of microstructures for each tile. In some implementations, an efficient global optimization algorithm is used that selects an optimal tiling of particular microstructures, taking into account that neighboring microstructures are properly connected. The inventors evaluated the algorithm by fabricating several examples of flat sheets with heterogeneous and anisotropic material behavior in 2D including measuring the elastic properties of the sheets and comparing the measurements to predicted values of a simulation. The inventors have also printed several 3D objects, e.g., a rabbit and a bear, that had differing elastic material behavior in differing regions or object elements due to the use of differing microstructures in these regions or object elements.

As an overview, a goal driving the design of the 3D printer system (such as system 100 of FIG. 1) is to provide a 3D printer that can automatically convert an object with given material parameters (such as elastic properties) into a 3D printable representation that requires only a single base material for fabrication but yet produces the desired elastic behavior. The input to the 3D printer system is the shape of the object plus a description of the elastic material parameters, which may be heterogeneous (e.g., vary among differing regions of the printed 3D object). In the following discussion, the material parameter will be assumed to have been chosen by a user of the 3D printer system to be elasticity or elastic behavior, and, in designing the system, the inventors limited themselves to small strains. The discussion demonstrates the design approach works well with both isotropic and anistropic elastic materials. The 3D printer system may be considered to provide (during its operation) two main stages of the printing process: (1) a pre-processing stage that constructs metamaterial structures (microstructures) covering the space of reproducible material properties and (2) a synthesis stage that uses those structures to generate the microstructures for use in printing a given 3D object.

With regard to metamaterial space construction, the pre-processing or first stage aims to define a function that efficiently maps a given elastic material to a small, tileable structure with the same bulk behavior. In one implementation, the process starts by systematically sampling the material parameter space. The strategy is to compute a sparse set of representative structures that: (a) cover a wide range in the space of elastic material parameters and (2) allow the interpolation of neighboring structures in parameter space. Then, via weighted combination of these samples, a continuous mapping is reconstructed from elasticity parameters to microstructures (which are then made available to a 3D printer as a library or database of microstructures to use in its 3D printing of objects to provide the elasticity parameters in its bulk material).

First, given an initial material parameter value, a corresponding microstructure is computed by solving an inverse optimization problem (as described below) followed by storing the value in a database/library. Second, neighboring values in parameter space are sampled and then optimized for their structures while enforcing a similar topology. This process is continued until the space cannot be expanded any further. Weighted combinations of these samples form a continuous family of microstructures that cover a subset of the material parameter space. If the overall space is not sufficiently covered, the process is repeated with a new “seed” to ultimately obtain a database or library containing several families of microstructures, with each covering its own subset of the parameter space. These subsets of the space or subspaces may be at least partially overlapping, which means the mapping from parameters to microstructures is one-to-many.

With regard to the synthesis stage, to synthesize the microstructures that are to be used to print a given 3D object, the interior of the 3D object can be tiled. For each tile, a microstructure is interpolated from each pre-computed family of microstructures. This provides a small set of structures for each cell, and one of these microstructures may be chosen for use in printing. The choices are made carefully in a coordinated way so that the microstructures connect well with the microstructures in neighboring tiles. This selection process may be considered a combinatorial problem, which can then be efficiently solved using an optimization method, e.g., based on message passing. The generated microstructures are then used to fabricate or print the 3D object using rapid prototyping technology (e.g., FFM or other 3D printers).

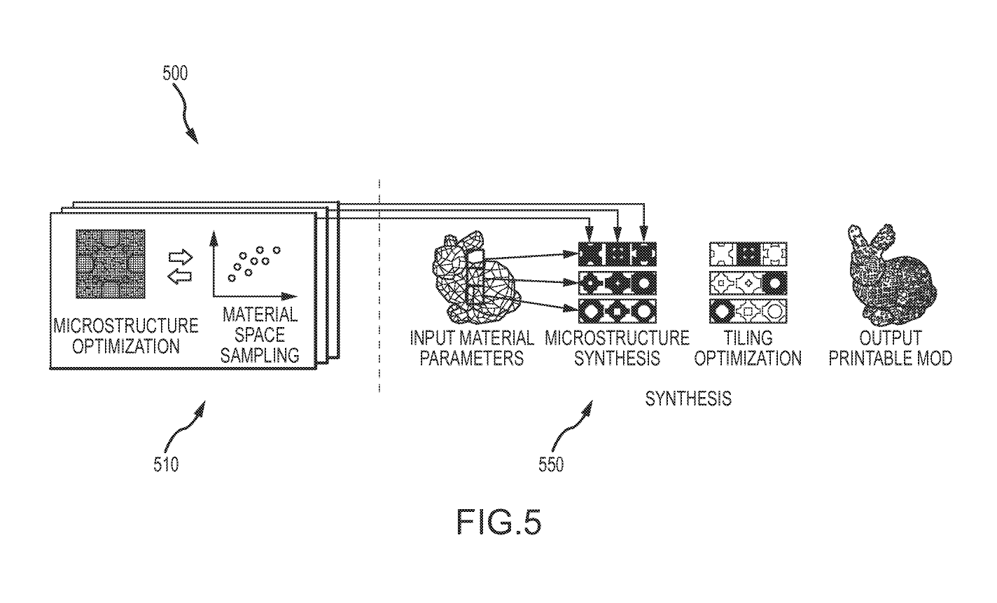

FIG. 5 is a flow diagram or schematic providing an overview of the 3D printing process 500 including the pre-processing and synthesis stages 510 and 550 as may be carried out during operation of the system 100 of FIG. 1. In the pre-processing step or stage 510, optimizing is performed for microstructures that span the space of reproducible materials. The synthesis step or stage 550 takes as input an object's 3D model (size and shape) along with specified material parameters. The synthesizing 550 is performed locally for microstructures that approximate or resemble the desired deformation behavior. Topologically different structures can have the same bulk behavior so that there potentially are multiple candidates of microstructures for a single location in the 3D object (e.g., in the 3D print file of the input 3D model of the object to be printed). Using these candidate microstructures, a globally optimal tiling of the microstructures is computed that ensures neighboring microstructures are properly connected (if not, different candidates are selected). Once the 3D print file is completed with its microstructures and their locations chosen/defined, the physical 3D object is generated by operating the 3D printer using the 3D print file.

In order to determine and optimize for the behavior of a microstructure, a physical model is introduced. This model combines a standard linear elasticity with extensions specific to microstructure simulation and topology optimization. Turning first to linear elasticity, continuum mechanics in combination with a finite elements discretization is one useful approach to model elastic structures. For the standard linear elasticity approach, the energy density can be defined as:

W=ε:C:ε=ε:σ Eq. (1)

where ε is the linear Cauchy strain, C is the material stiffness tensor, and σ=C:Γ is the Cauchy stress tensor. The material stiffness tensor is defined by a small set of parameters that depend on the material model. For example, for an isotropic material, it is a function of two parameters: the Young's Modulus and the Poisson's Ratio. For more complex materials, additional parameters such as the shear modulus and direction-dependent Young's Moduli and Poisson's Ratios are used Given parameters, p, the corresponding material stiffness tensor can be denoted as C(p).

A linear finite element method may be used to discretize Equation (1) with basis functions defined on triangular and tetrahedral elements in 2D and 3D, respectively. In this case, the strain is constant within an element. The elastic energy, given as the volume integral of the energy density, is then:

Uₑₗ=Σᵢ₌₁^{k}(εᵢ:Cᵢ:εᵢ)Vᵢ Eq. (2)

for a model with k elements and element areas/volumes Vᵢ.

The total energy of the system also considers external forces and tractions. Summarizing surface traction and forces using a general force field, f, acting on vertices, this energy can be expressed as:

Uₜₒₜ(x)=Uₑₗ(x)−Σᵢ₌₁ⁿxᵢ^{T}fᵢ Eq. (3)

where n is the number of vertices, and vector x=[x₁^{T} . . . xₙ^{T}] is the concatenation of all vertex position vectors. The deformed configuration, x, corresponding to the static equilibrium can be computed by minimizing this energy, or equivalently, solving:

∇ₓUₑₗ(x)=f Eq. (4)

Since the elastic energy is invariant to translation and rotation, the solution to this problem is not unique. A common work-around to this is to constrain enough degrees of freedom to get rid of this null space. However, the choice of degrees of freedom might influence the solution in the presence of forces. Instead, the inventors opted to resolve the ambiguities by introducing constraints on the moments of the object. These constraints take the form:

$${c}_{1} ( x ) = {\sum }_{i = 1}^{n} ( {x}_{i} - {X}_{i} ) = 0 \\ {c}_{2} ( x ) = {\sum }_{i = 1}^{n} ( ( {x}_{i} - {X}_{i} ) \times ( {x}_{i} - \overline{X} ) ) = 0 \qquad Eq . ( 5 )$$

where Xᵢ is the rest state position of vertex i, and X̅ is the mean rest state position. For simplicity, these constraints can be combined into a single vector c(x)=[c₁(x)c₂(x)]^{T}. Intuitively, these constraints fix the mean translation and rotation. To compute c₂ in the 2D case, positions can be treated as points on the z=0 plane and the z-component of the cross product can be used.

Combining Equations (4) and (5), the problem of computing the equilibrium configuration then becomes:

∇ₓUₑₗ(x)=f s.t. c(x)=0 Eq. (6)

This problem can be expressed as a system of linear equations and efficiently solved.

Turning now to microstructure simulation, the simulation of a microstructure can be simplified by considering a tiling of a representative base cell. Instead of simulating the complete tiling to determine the behavior of the microstructure, periodic boundary conditions can be added to a simulation of a single base cell. These boundary conditions simulate the tiling and essentially require that opposite boundaries of the cell have the same shape.

Specifically, it can be assumed that any vertex on a boundary has a matching vertex on the opposite boundary such that its relative position on the boundary is identical. Choosing an arbitrary pair of boundary vertices x₀^{base} and x₁^{base} as base vertices then defines the distance between two opposite boundaries, and any other vertex xᵢ on one boundary is then expressed as a combination of the base vertices and the corresponding vertex xᵢ on the opposite boundary:

xᵢ=x₁^{base}+xⱼ−x₀^{base} Eq. (7)

These boundary conditions can be efficiently integrated into a simulation by removing the corresponding vertices from the degrees of freedom.

With regard to numerical coarsening, optimizing a microstructure can be thought of as an inverse problem that corresponds to the forward problem of determining the coarse-scale behavior from the microstructure. This forward problem can be defined using the idea of homogenization: compute a material stiffness tensor for a homogeneous material whose elastic behavior matches that of the tiled microstructure. Turning first to harmonic displacements, to describe the deformation behavior of the microstructure, a set of representative displacements are computed for different load cases. These harmonic displacements, h_{ab}, are defined as the solution to the following boundary value problem:

$$\begin{matrix}∇ \cdot σ ( {h}_{ab} ) = 0 & inside Ω \\ σ ( {h}_{ab} ) \cdot n = \frac{1}{2} ( {e}_{a} {e}_{b}^{T} + {e}_{b} {e}_{a}^{T} ) \cdot n & on \partial Ω\end{matrix} \qquad Eq . ( 8 )$$

where, eₐ is the unit vector along the a-th coordinate direction,

$$\frac{1}{2} ( {e}_{a} {e}_{b}^{T} + {e}_{b} {e}_{a}^{T} )$$

describes the tractions on the surface ∂Ω of the object domain Ω, and n is the surface normal. For tiled structures, this surface is the boundary of the base cell.

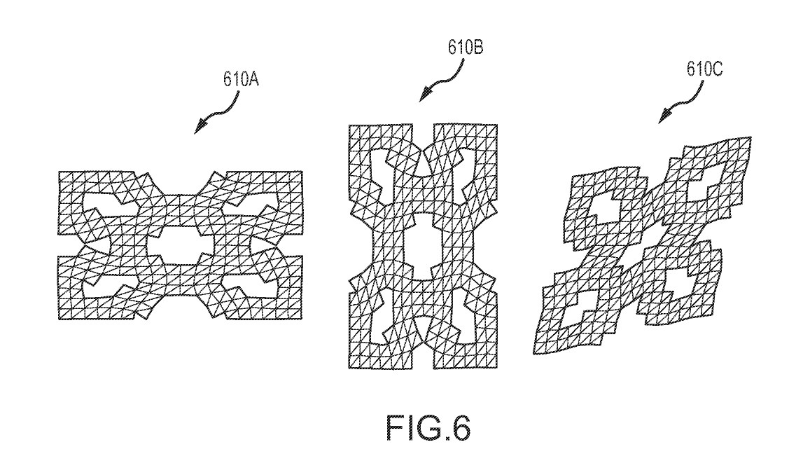

Considering symmetries, there are three and six distinct harmonic displacements in 2D and 3D, respectively. FIG. 6 illustrates a set of harmonic displacements for a microstructure 610A, 610B, and 610C in 2D. From these displacements, a 4-th order deformation tensor, G, can be defined per element:

G_{klab}=(ε(h_{ab}))ₖₗ Eq. (9)

This tensor contains the Cauchy strain for every displacement, and, by considering the elasticity equation (i.e., Equation (1)) as a bilinear equation, the term G^{T}:C:G describes the energy density for any pair of harmonic displacements.

Turning now to coarsening, the homogenized material stiffness tensor can now be computed from the deformation behavior of the microstructure. The deformation is first transferred from the harmonic displacements of the microstructure to a coarse mesh made up of only a single voxel of the size of the base cell. For the case where the corners of the base cell correspond to vertices of the fine mesh, this simply means transferring the displacements at the corner. For the general case, the displacement is transferred by computing a distance-weighted interpolation of a set of nearest neighbors in the fine mesh, while adhering to the periodic boundary conditions. After the deformation has been transferred to the coarse mesh, a tensor, [symbol] , can be defined. The coarsened material stiffness tensor for the coarse mesh is then obtained analytically as

$$= {- T}^{} : ( {\sum }_{i = 1}^{k} \frac{{V}_{i}}{V} {G}_{i}^{T} : {C}_{i} : {G}_{i} ) : {- 1}^{} \qquad Eq . ( 10 )$$

where Vᵢ is the area/volume of element i in the fine mesh, and V is the area/volume of the base cell. Due to the periodic boundary condition for microstructures, the strain in the coarse mesh is uniform, and a single material stiffness tensor can be computed for the whole base cell. Note that the Voigt compressed matrix representation may be used to express all tensors. This is especially useful when computing [symbol] ⁻¹, which can be computed as a simple matrix inverse instead of a more complex symmetric tensor inverse.

Turning now to microstructure optimization, one useful method for performing microstructure optimization solves the inverse problem to the numerical coarsening method by solving for a microstructure that coarsens to a given stiffness tensor. Optimizing a microstructure requires a way to define and alter the material distribution within a base cell. A common approach in topology optimization is to discretize the material distribution by subdividing the base cell into a grid of material voxels, where each voxel is associated with a binary activation that described whether the voxel is full (1) or void (0).

Optimizating the microstructure using these binary variables directly would be infeasible for moderately large grids. Instead, the problem can be relaxed by allowing the activations to vary smoothly between 0 and 1 during the optimization and only requiring them to converge to a binary solution at the end of the optimization. For the continuous activations, a meaningful interpolation between void and full voxels can be defined such that the activation corresponds to a physical quantity in the simulation. A simple way to define this is by using interpolation between stiffness tensors. For any voxel i (1≦i≦m, with m being the number of voxels), an individual material stiffness tensor Cᵢ is defined as an interpolation between the base material stiffness tensor C_{base} and air, which is assumed to have a zero stiffness tensor:

Cᵢ=aᵢC_{base} Eq. (11)

To ensure numerical stability, the minimum of aᵢ is set to aₘᵢₙ=10⁻⁵. The number of activations can be reduces by exploiting symmetries of the goal material. For example, for a cubic material, the response along each axis has to be identical. Mirroring the symmetries along all axes and all diagonal planes will, therefore, not constrain the solution.

The problem, of finding a microstructure that exhibits a large-scale behavior identical to a homogeneous material with desired material parameters, p_{goal}, can be formulated or posed as a least squares problem. From the parameters p_{goal}, a stiffness tensor C^{goal}=C(p_{goal}) can be computed. The optimization then modifies the activations α such that the homogenized stiffness tensor [symbol] computed according to Equation (8) matches the goal stiffness tensor as closely as possible.

However, the homogenized stiffness tensor, [symbol] , is not a direct function of the design variables, α, but only of the harmonic displacements, h_{ab}. To propagate changes of α towards [symbol] , Equation (8) can be included as a constraint. The optimization problem can then be defined as:

$$\begin{matrix}{min}_{α} & {‖ {C}^{goal} - ‖}_{F}^{2} + R \\ s . t . ∇ ( {h}_{ab} ) \cdot σ = 0 & inside Ω \\ σ ( {h}_{ab} ) \cdot n = \frac{1}{2} ( {e}_{a} {e}_{b}^{T} + {e}_{b} {e}_{a}^{T} ) \cdot n & on \partial Ω \\ {α}_{min} \leq {α}_{i} \leq 1 & 1 \leq i \leq m\end{matrix} \qquad Eq . ( 12 )$$

where R is a combined regularization term. While other approaches in microstructure optimization could be used that try to find extremal properties for a specified amount of material, the described approach or formulation differs in that it tries to match the given parameters regardless of the amount of material used

With regard to regularization, while the optimization problem (i.e., Equation (12)) could be solved without any regularization, the result will generally not be fabricatable. In order to achieve fabricability (printable by a 3D printer), the inventors add three different regularization termsRᵢₙₜ, Rₛ and R_{cb} with corresponding weights wᵢₙₜ, wₛ and w_{cb} to the objective. The combined regularization term R is defined as

R=wᵢₙₜRᵢₙₜ+wₛRₛ+w_{cb}R_{cb} Eq. (13)

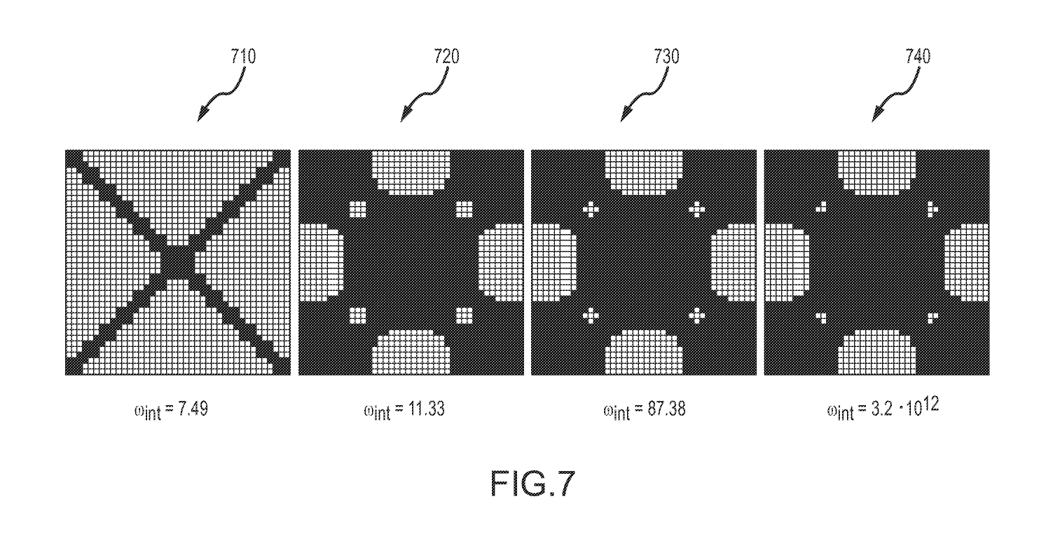

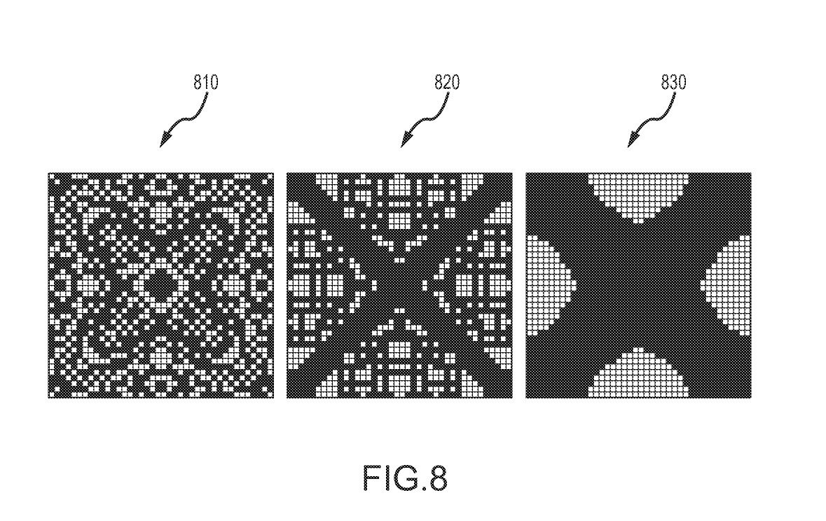

FIGS. 7 and 8 show different stages of optimization at 710, 720, 730, 740 (optimization at different stages with different penalty weights to force the activations towards aₘᵢₙ or 1) and at 810, 820, 830 (showing influence of different regularizations with 810 showing optimization results where only integer values are enforced, with 820 showing additional anti-checkerboard regularization, and with 830 showing smoothness regularization). In FIG. 5, the objective value for the last two results 820 and 830 is similar while the first result 810 has a worse objective value. The optimizations shown in FIGS. 4 and 5 are elaborated (including an elaboration of each term) is provided in the following paragraphs.

It may be desirable to enforce integer values. Particularly, while the simulation allows activations, α, to vary freely between aₘᵢₙ and 1, these configurations do not correspond to valid physical objects. For fabrication, the activations should be integral (excluding the small offset, αₘᵢₙ, to ensure stability). In order to reach such a solution, the regularization term Rᵢₙₜ acts as a penalty for activations that are not equal to either αₘᵢₙ or 1:

Rᵢₙₜ=Σᵢ₌₁^{m}(αᵢ−αₘᵢₙ)(1−αᵢ) Eq. (14)

While this regularization can ensure that the final activations are equal to αₘᵢₙ or 1 by setting the weight to a sufficiently high value, this would ignore the objective. Instead, the weight wᵢₙₜ can be gradually increased during the optimization to reach a solution that respects the objective as well as possible. For each value of the weight, a full optimization is run until convergence is reached. If the solution is not binary, the weight is increased and the optimization resumed. FIG. 7 shows different stages 710, 720, 730, 740 of the optimization with different weights wᵢₙₜ.

Further, it may be desirable to perform the optimization to ensure or provide better smoothness. The size of a single microstructure cell in a fabricated object is largely defined by the following two factors: (1) the resolution of the 3D printer and (2) the size of the smallest detail in the microstructure. Smaller base cells provide a better approximation of a continuous material. Since the printer resolution is assumed to be fixed, microstructures without small details may be preferable.

The regularization Rₛ views the activations as an approximation of a material distribution field and uses a second-order finite difference approach to penalize deviations from smoothness. For this purpose, any component of α can be assumed to have two indices in 2D, such that a_{i,j} corresponds to the voxel (i,j). The regularization then has the form:

Rₛ=Σ_{i,j}(α_{i-1,j}+α_{i+1,j}+α_{i,j-1}+α_{i,j+1}+4α_{i,j})² Eq. (15)

This regularization can be trivially expanded to 3D.

In the optimization, it may be useful to address checkerboard patterns. An artifact that frequently appears in topology optimization is elements that are connected by a single vertex, which is often referred to as checkerboard patterns. To avoid such structures, the regularization R_{cb} penalizes configurations that contain checkerboard patterns, as illustrated in FIG. 8. In 2D, this regularization is based on 2×2 patches of voxels and has the form:

R_{cb}=Σ_{i,j}(1−α_{i,j})(α_{i+1,j}−αₘᵢₙ)(α_{i,j+1}−αₘᵢₙ)(1−α_{i+1,j+1})+(α_{i,j}−αₘᵢₙ)(1−α_{i+1,j})(1−α_{i,j+1})(α_{i+1,j+1}−αₘᵢₙ) Eq. (16)

In the case of binary activations, R_{cb} is only non-zero if the structure contains a checkerboard pattern. In the continuous case, the regularization also acts as an additional regularizer that pushes the activations towards αₘᵢₙ or 1. In 3D, the number of different local checkerboard patterns increases. Additionally to 2×2×1 patches with every possible orientation, checkerboard patterns for 2×2×2 patches should be taken into account. Nonetheless, this is a relatively simple extension of the 2D case.

An additional fabrication requirement that typically should be considered is connectivity. While the optimization might prefer to generate regions of material that are not connected, these structures would fall apart when fabricated (e.g., printed using a 3D printer). To prevent the optimization from converging to such a solution, disconnected components are preferably detected such as after every iteration based on a threshold on the activations. If a disconnected component has been found, it is either connected to the rest of the microstructure (e.g., by computing the minimal change necessary for such a connection) or deleted (e.g., if the deletion causes less damage than the connection).

In 3D, an additional fabrication may be desirable. While 3D printing can handle complex structures, most approaches rely on support material to create overhanging structures. This support material has to be removed (typically manually) after printing is completed. This means that every void voxel in the microstructure should be connected to the boundary of the cell. To this end, one can use the same approach as for connecting components, but the role of void and full voxels can be switched. In practice, the inventors have not yet observed any convergence problems due to these additional constraints.

With regard to specific numerical methods, the optimization problem (i.e., Equation (12)) can be solved with L-BFGS-B (or similar methods) as this enforces the boundary constraints. For the remaining constraints, a two-phase approach can be used Particularly, the equilibrium defined by the constraints is recomputed whenever the state variables change so that the constraints are always satisfied for every evaluation of the objective and gradient Since for this approach the harmonic displacements, h_{ab}, are assumed to be a function of the activations, the proper computation of the derivatives may require the Jacobian of these displacements with respect to the activations. The adjoint method can be used to compute the derivative efficiently. Taking the derivative of the minimum condition ∇ₓUₑₗ=0 as well as the constraints c=0 results in:

$$\begin{matrix}\frac{{\partial }^{2} {U}_{el}}{\partial x \partial α} + \frac{{\partial }^{2} {U}_{el}}{\partial {x}^{2}} \frac{dx}{d α} = 0 & \\ s . t . & \frac{\partial c}{\partial x} \frac{dx}{d α} = 0\end{matrix} \qquad Eq . ( 17 )$$

Solving this system of equations requires only a single sparse matrix decomposition.

Turning now to metamaterial space construction, the optimization provided above is able to produce microstructures for a variety of material parameters. However, it may take a long time (or a significant amount of computation) to generate a desired model of a 3D object with such microstructures. Moreover, if the desired 3D object contains spatially-varying parameters (so that many optimizations would be run to generate the corresponding microstructure), this method may quickly become infeasible for implementation (such as using a 3D printer's controller or the like). To avoid this problem, the inventors propose a data-driven approach to assemble or provide structure synthesis of (as discussed below and as may be implemented by the print control program or additional software running on a 3D printer) a printable model or 3D structure for an entire input model of a 3D object by using a database or library of microstructures, which were generated and stored in memory ahead of time (e.g., in the pre-process stage shown in FIG. 5).

In order to be able to assemble microstructures for any object, it is useful to define a set of microstructures with two properties. First, the microstructure should span a wide range of parameter values. Second, the microstructures should also need to be similar enough to facilitate interpolation between microstructures in a continuous way. In the following paragraphs, a description is provided of applying the methods discussed above to find sets of microstructures that can be interpolated to define continuously variable microstructures that cover subsets of the space of material parameters. Several continuous families are explained for use together to assembly models spanning the entire range of achievable material parameter values or material properties.

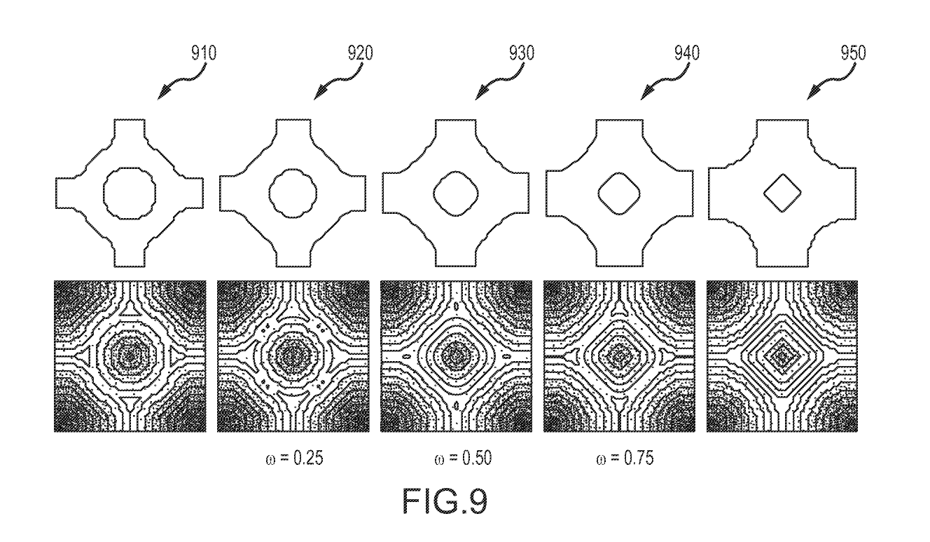

With regard to interpolation, in order to generate microstructures for material parameters that fall between the parameters of the microstructures that have been computed, it may be useful to interpolate among the shapes of these known microstructures. Shape interpolation can be done in many ways. For example, one can perform the interpolation by converting the shapes to signed distance functions and then interpolating those functions. Starting with a parameter space point where it is desired to interpolate a microstructure, a set of nearest neighbors can be collected from the parameter space. Then a signed L₁-distance field can be computed for each of the microstructures such as by using a grid of twice the resolution that the optimization uses. Moving Least Squares may be used with an inverse distance kernel to compute weights for these neighbors, and, then, a weighted sum of the distance fields can be computed. Next, the interpolated structure can be extracted from this blended distance filed using Marching Squares or Marching Cubes in 2D and 3D, respectively. FIG. 9 illustrates results 920, 930, 940 of the interpolation process between the microstructure 910 and the microstructure 950 for different weights (with the bottom row showing corresponding signed distance fields (darker shading representing positive and lighter shading representing negative)). The choice of a weighting kernel guarantees that the original microstructures are reproduced exactly at the sample points.

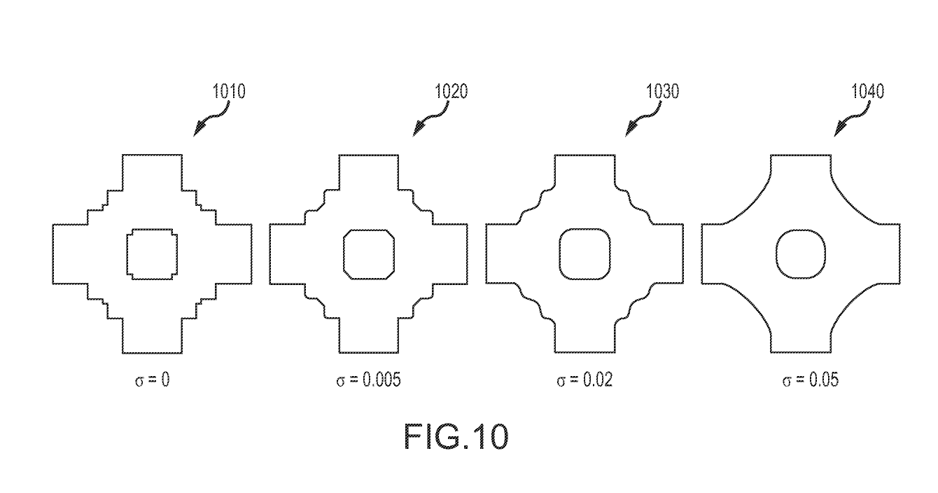

While this process gives an appropriate interpolation by itself, an additional Gaussian smoothing step may be performed on the interpolated distance field. FIG. 10 illustrates results 1010, 1020, 1030, and 1040 of the smoothing pass for different Gaussian spread values σ. This results in a smoother mesh and removes the typically unwanted stair structures that are due to the voxelization. These sharp corners could otherwise lead to localized stresses under deformation, and the printed 3D object may more easily fracture. To ensure that this property carries over to the final output, the Gaussian smoothing can also be used when estimating the parameters of each structure. While this changes the material stiffness tensor estimate from the numerical coarsening, it may ensure that the interpolation is exact at the parameter space sample points.

With regard to stiffness tensor projection, numerical coarsening can be used to compute a stiffness tensor that describes the behavior of a base cell. However, this tensor may have too many degrees of freedom to allow for an efficient sampling of the parameter space (e.g., 6 in two dimensions and 21 in three dimensions). By considering only isotropic, cubic, or orthotropic materials, the parameter space can be reduced to a subset of material tensors, while still offering enough freedom to show a large variety of deformation behaviors. To approximate the parameters from a material stiffness tensor computed by numerical coarsening, a simple constrained least-squares approach can be used. Assuming a material stiffness tensor Ĉ is given, the corresponding parameters are computed by solving:

$$\begin{matrix}{min}_{p} {‖ C ( p ) - \hat{C} ‖}_{F}^{2} & \\ s . t . & {p}_{i}^{min} \leq {p}_{i} \leq {p}_{i}^{max}\end{matrix} \qquad Eq . ( 18 )$$

The function C(p) is defined by the choice of the material model, and pᵢ^{min} and pᵢ^{max} are the physics-based bounds on the parameters, such as the upper limit of 0.5 for the Poisson's Ratio of isotropic materials.

Now, it may be useful to discuss parameter space sampling. In order to generate a set of microstructures that can be interpolated to define a continuously varying structure or 3D object, a set of microstructures is desired that are well spread out in parameter space. To this end, points in the parameter space can be selected, and an optimization can be run for each of these samples. While the space could be sampled randomly, this may become infeasible for more complex material models, and, since there might be many solutions for one sample, the resulting microstructures would likely be unfit for interpolation.

Instead, an initial sample can be chosen either by generating a single random sample or by using a microstructure that was designed by hand. Based on this initial sample, the algorithm used by the inventors tries to expand the region that is covered by the existing samples by first choosing additional samples in random directions and, later, by sampling the convex hull of all samples and adding an offset along the normal direction. Additional sampling points are added in interior regions where the interpolation does not produce good results. This may be done by constructing the Delaunay triangulation of all points in the parameter space and computing the interpolation at the center of every simplex. The material parameters of this structure are then estimated, and, if the difference to the sample parameters is above a defined threshold, the point is added as another optimization sample. The actual range of possible parameters depends on parameters of the base material. To guarantee an appropriate sampling of the space regardless of the base material parameters, all points in the parameter space can be normalized before any operation is performed by dividing parameter components that are associated with a unit (e.g., MPa) by the corresponding component of the base material parameters.

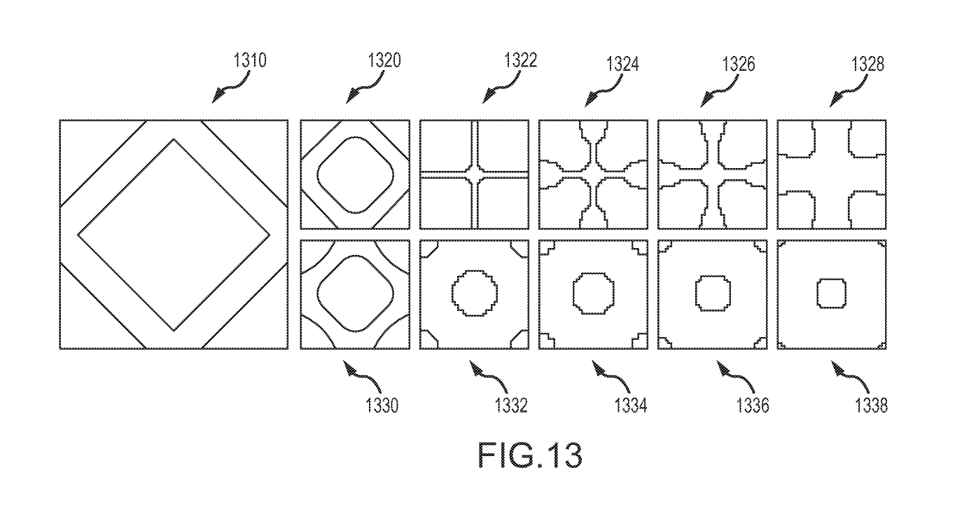

For any new microstructure optimization that is run for a given set of parameters, the result should be similar to the existing microstructure to improve the interpolation. To lead the optimization into the desired direction, an additional regularization can be added to the optimization. This regularization penalizes the amount of change between a new structure and the structure of the N neighbors in parameter space closest to the goal parameters. To allow for small changes, this penalty can use the exponential function:

$${R}_{sim} = {\sum }_{i = 1}^{N} {w}_{sim}^{i} {e}^{{( \frac{{\sum }_{j = 1}^{m} \vert {α}_{j} - {a}_{j}^{i} \vert}{{Δα}_{i}} )}^{2}} \qquad Eq . ( 19 )$$

where wₛᵢₘⁱ is the weight for neighbor i, αⱼⁱ is its j-th activation and Δαᵢ is a threshold for the maximal desirable difference to this neighbor. For a specific optimization, the value Δαᵢ can be set proportional to the distance of the desired parameters to its neighbor i. Additionally, the initial activations for the optimization are set to a weighted average of the neighbors after a smoothness step is applied. This reduces the risk of ending up in a local minimum. FIG. 13 illustrates a starting initial structure 1310 and microstructures generated without similarity regularization (1320, 1322, 1324, 1326, and 1328) and with similarity regularization (1330, 1332, 1334, 1336, and 1338).

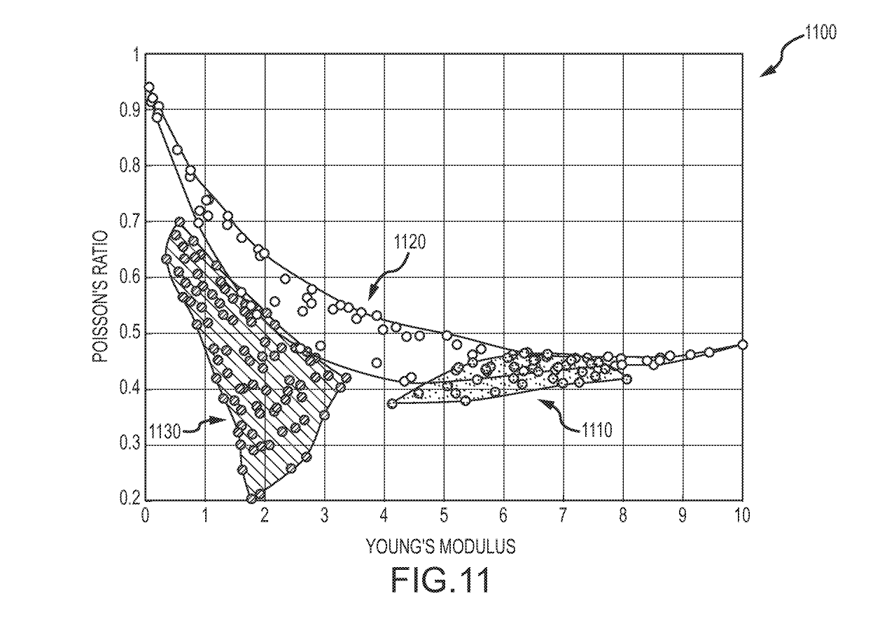

Now, returning to the topic of structure synthesis, several families of related microstructures can be defined that together span the feasible range of macroscale material parameters using the microstructure optimization and parameter space sampling methods. This is shown in the graph 1100 of FIG. 11 with data points for three different parameter spaces 1110, 1120, and 1130 for a cubic material in 2D (note, though, the values for the shear modulus are omitted). However, simply combining them into a single set typically does not lead to a satisfying result. Interpolating between dissimilar microstructures often leads to disconnected islands in the resulting 3D object or model of such an object and jumps in an ideally smooth interpolation path due to topology changes.

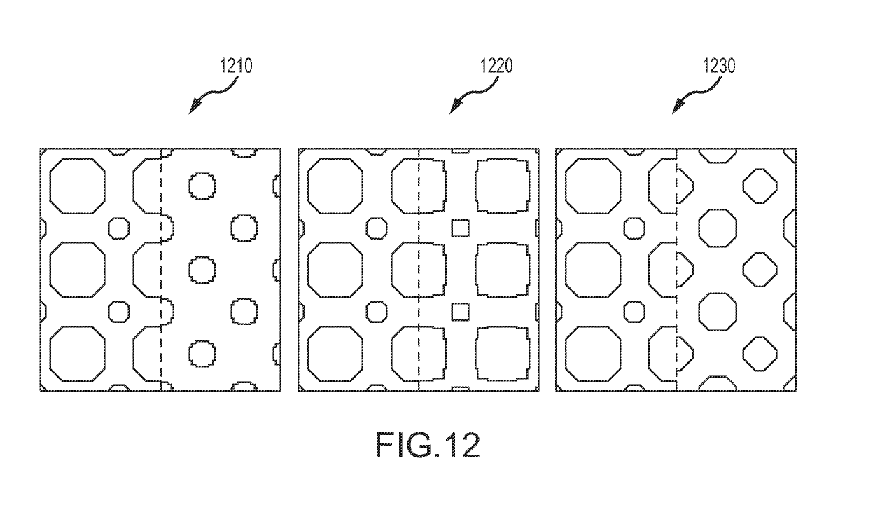

Rather than combining multiple sets, the individual sets can be used to generate a pool of candidate microstructures for any desired parameters (or any values or ranges of values for a particular material parameter). However, simply choosing the candidate microstructures independently at each point in the print model could lead to a mismatching boundary when multiple different microstructures are tiled together. This is shown in FIGS. 12 at 1210, 1220, and 1230 for three potential configurations of two neighboring cells or microstructures. At 1210, the individual microstructures closely match the desired parameter values (e.g., a particular elasticity), but their boundaries are incompatible. At 1220, the opposite case is shown. At 1230, the optimization described herein computes a trade-off between the two extremes shown in 1210 and 1220. On the other hand, choosing all microstructures from the same set would likely lead to good tiling but a poorer approximation of the desired parameters. To compute an optimal selection from the candidates, an optimization proposed by the inventors tries to minimize the boundary dissimilarity of neighboring microstructures as well as the interpolation error.

For a set of cells with desired parameters, p₁, . . . , pₖ, and information about the connectivity between cells, all structures that can be generated from all the families of microstructures are collected. The result is a group of microstructures, S_{i,1}, . . . , S_{i,l}, for every parameter sample, pᵢ. Finding the optimal choice of microstructures can then be formulated as a labeling problem. Specifically, the optimal solution assigns a structure to each cell such that a given cost function is minimized. A cost function may be used that contains two different types of costs. Labeling costs describe how well a given structure matches the desired parameters. For a fast computation, this cost is chosen to be the distance of a parameter sample to its nearest neighbor, which measures the uncertainty of the interpolation. If computation time is not important, the actual material parameters can be approximated by numerical coarsening. In this case, the labeling cost is the difference between the desired parameters and the coarsened parameters. The second term of the cost function describes the dissimilarity between the boundaries of two structures. For any pair of neighboring microstructures, this is the percentage of boundary voxels that do not match.

Finding the globally optimal solution to this optimization problem is NP-hard. However, efficient algorithms exist that can find an approximate solution. In one implementation, an iterative method is employed using message passing based on the alternating direction method of multipliers (ADMM). For the resulting microstructures, the distance field can then be combined. To improve connectivity between cells, the smoothing pass is performed on the combined distance field instead of each cell individually. The final structure is reconstructed from the combined distance field using Marching Cubes.

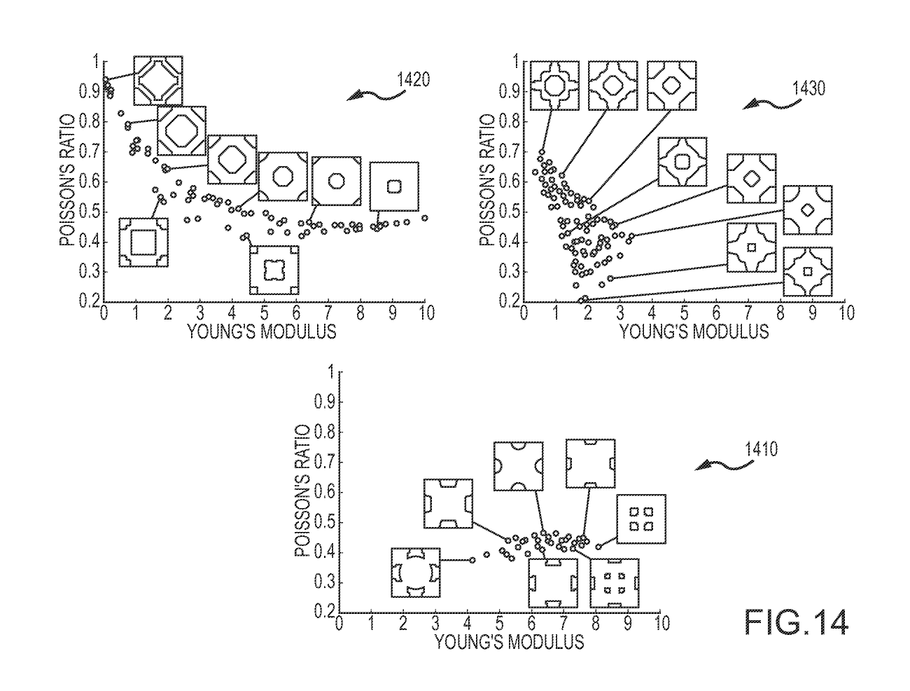

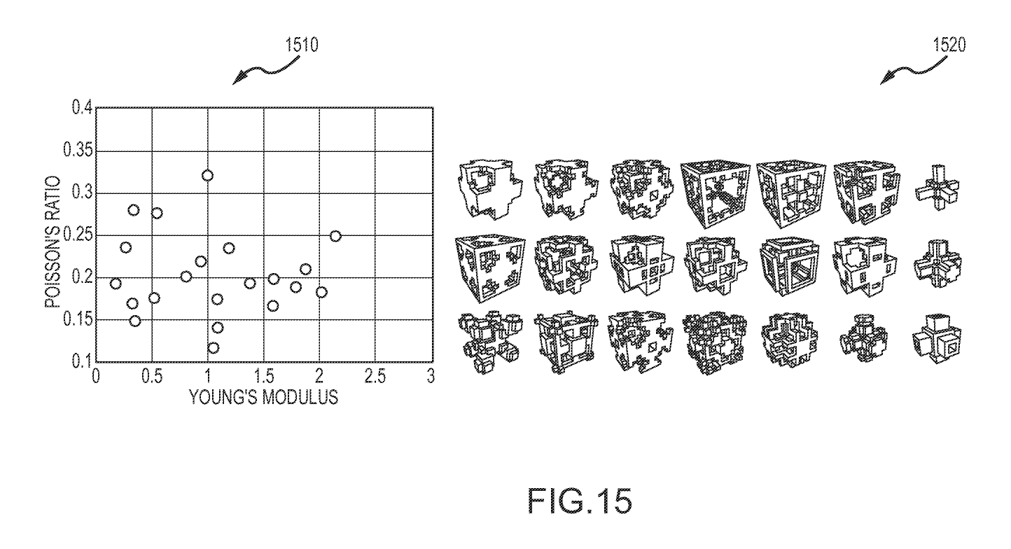

At this point in the description, it may be useful to describe results that have been obtained using the system and method taught herein. Particularly, with regard to metamaterial space construction, the inventors tested the 3D printing method on different material types. In 2D, sets of microstructures were generated with a resolution of 40² voxels for isotropic material (2 parameters), cubic materials (3 parameters), and orthotropic materials (4 parameters). Due to the inherently anisotropic nature of square and cubic microstructures, a cubic material space was found to be better suited for creating microstructures even for cases where one is only interested in the Young' Modulus and Poisson's Ratio of a material. FIG. 11 shows with graph 1100 the Young's Modulus and Poisson's Ratio of multiple spaces 1110, 1120, 1130 for a cubic material. FIG. 14 illustrates with graphs 1410, 1420, and 1430 the individual spaces from FIG. 11 including a visualization of some of the microstructures. While a single space may span a wide range of parameters, this example shows that combining multiple spaces can significantly expand this range. The method described herein was also used to compute a set of 3D material structure or microstructures with a resolution of 12×12×12 voxels as shown in FIG. 15 with graph 1510 and the set 1520 of exemplary microstructures (which can be used to form a print model to control a 3D printer to print a 3D object with a desired elastic behavior in one or more of its regions or object elements).

For the microstructure optimization in 2D with a resolution of 402, a single optimization step took around 400 to 800 milliseconds to compute. The optimization usually converged in less than 500 iterations. An optimization in 3D with a resolution of 12³ ran with 8 to 20 seconds per iteration and usually also converged in less than 500 iterations. For the structure synthesis, the inventors tested the runtime of the optimization by combining three metamaterial spaces for different numbers of cells. For 400 cells, the optimization took about 0.5 seconds, for 2500 cell it took about 2 seconds, and for 10000 cells it took about 40 seconds. The actual runtime for optimizing the microstructure of an object can likely be reduced by clustering cells with identical or similar parameters.

The described method relies on the ability to compute the material behavior of a microstructure from its design. To validate the results obtained by numerical coarsening, the inventors tested several of the generated microstructures in a tensile test and compared these results with the predicted material parameters for these microstructures. Since the material parameter was linear elasticity, the numerical coarsening and the optimization itself are independent of the Young's Modulus of the base material. The result can be adapted to any material with the same Poisson's Ratio by a simple scaling, which means the ratio of the computed Young's Modulus of the microstructure and Young's Modulus of the base material is constant.

The samples were fabricated using two different additive manufacturing techniques. For the 2D examples, a polyjet 3D printer with an elastic, rubber-like material (i.e., Stratasys TangoBlackPlus) was used as the base material, and, for the 3D examples, selective laser sintering was used with an elastic thermoplastic polyurethane (i.e., TPU 92A-1). To perform the tensile tests, an Instron E3000 frame was used with a 5 kN load cell and 10 cm pneumatic grips. First, the base material was characterized using dog bone-shaped structures. To measure the tensile strength of the microstructures, samples were created that were made up of a grid of 7×14 unit cells to reduce boundary effects. After clamping, the samples were slightly pre-stretched (e.g., <1 MPa) and tested with a constant displacement rate of 20 mm/minute. The tensile test results suggested a good fit in the small strain regime (up to 10 percent) between the predicted structural properties and the experimental data with objects formed with the microstructures.

The inventors tested their structure synthesis method on a simple material gradient example. The Young's Modulus and shear modulus were specified for a 7×14 grid and the synthesis algorithm was run with different settings and input. Using a single set of microstructures resulted in a good matching at the interface of the single cells or microstructures with an average boundary dissimilarity of below 2 percent. However, the average normalized distances between the simulated parameters of the generated structures and the desired parameters were relatively large. By considering multiple sets of microstructures and computing the homogenized parameters of every interpolated structure, one can greedily choose the best structure for each cell to achieve an average normalized distance (e.g., distance of 0.071 in one example). However, there is no guarantee that these structures fit together. While the inventors did not encounter any dangling structures for their test run, with 7.4 percent boundary dissimilarity, the mismatch at the boundaries was larger. Using the synthesis method discussed earlier in the description, one can solve for parameter approximation and boundary similarity at the same time. While the approximation of the desired parameters for the individual cells is worse than for the greedy solution, with an average normalized distance of 0.073, the boundary dissimilarity in the resulting printed/fabricated object was significantly better (at 3.1 percent in this example).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

In one exemplary implementation, the input to the 3D printer system was a model with specified elastic parameters. The 3D printer system then computes or generates the small scale microstructures or cells that are useful to provide or at least approximate an object (or portion of such an object) formed with a material that provides those elastic parameters. This is useful for providing more local control of the deformation of the object (or its portions/elements). The 3D printer system synthesizes the desired microstructures or cells from pre-computed material subspaces and is able to handle 3D objects made up of thousands of layers and microstructures within a relatively short computation time (e.g., within seconds in most cases).

The 3D printer system and associate printing method provides a number of advantages including: (a) increased accuracy as it allows control over the microstructures themselves; (b) increased speed as the system/method can handle objects made up of thousands of object parts with distinct material parameters (e.g., elasticity) in seconds; (c) automation as the system/method can automatically compute the microstructures and/or their combination/tiling to achieve desired material parameters for a portion of an object (i.e., for an object element); and (d) guaranteed fabricability of the model with the numerous microstructures as the microstructures are designed to support 3D printing (or are 3D printable when taken alone and in combination to form a portion or element of a 3D object).

The 3D printer or print assembly may take the form of a fused filament fabrication (FFF) printer, with a material supply including a spool of plastic filament. In other cases, though, other 3D printer technologies may be utilized to practice printing processes described herein. For example, the 3D print assembly may be granular (or powder-based) such as by making use of selective laser sintering, selective laser melting, selective heat sintering, or any printer that uses a powder and fuses it using heat. In other cases, the 3D print assembly may be configured to be photoreactive polymer-based such as one using stereolithography or PolyJet technology or to be plaster-based using powder and binding material deposited by a printing head. In other cases, the 3D print assembly may utilize laminated object manufacturing (e.g., fusing layers of cut material).

We claim:

1. A system for fabricating a physical three dimensional (3D ) object, comprising:
a 3D print assembly adapted for additively forming the 3D object;
a material supply providing print material to the 3D print assembly to form the 3D object;
memory storing a plurality of definitions of microstructures; and
a print controller running a control program, wherein the control program operates the 3D print assembly to form the 3D object based on a print file defining object elements of the 3D object and wherein the object elements are formed by fabricating a plurality of the microstructures.

2. The system of claim 1, wherein each of the microstructures is associated with a range of values for a material parameter.

3. The system of claim 2, wherein the material parameter is elastic deformation.

4. The system of claim 2, wherein the range of values is defined for the print material provided by the material supply.

5. The system of 4, wherein the 3D print assembly comprises a fused filament fabrication (FFF) printer and the material supply comprises a spool of plastic filament.

6. The system of claim 1, wherein the control program generates the print file from a 3D model including a first material parameter definition for a first region and a second material parameter definition for a second region and wherein the control program generates the print file to include a first one of the microstructures in the first region and a second one of the microstructures in the second region, whereby material parameters vary for the object elements of the formed 3D object.

7. The system of claim 6, wherein the first region and the second region mate at a boundary and wherein the control program selects the first and second ones of the microstructures to have compatible outer structures to bind together adjacent ones of the microstructures in the 3D object.

8. A method for forming a 3D object, comprising:
providing a library of predefined microstructures each associated with a value range for a material parameter;
receiving or retrieving a 3D model of an object with a region assigned a value of the material parameter;
identifying one of the predefined microstructures having one of the value ranges for the material parameter that includes the value of the material parameter; and
generating a print file for a 3D printer by processing the 3D model of the object to include a plurality of the identified one of the predefined microstructures in the region assigned the value of the material parameter.

9. The method of claim 8, wherein the 3D printer comprises an FFF-type 3D printer and the print file comprises a plurality of print layer definitions to form the plurality of the identified one of the predefined microstructures in the region.

10. The method of claim 9, wherein the 3D printer includes a spool of a filament formed of a plastic and wherein the value range for the material parameter for each of the predefined microstructures is defined for the plastic.

11. The method of claim 8, wherein the material parameter is elasticity.

12. The method of claim 8, wherein the 3D model comprises a second region assigned a second value of the material parameter differing from the value of the material parameter and wherein the identifying includes identifying a second one of the predefined microstructures having another one of the value ranges for the material parameter that includes the second value of the material parameter, whereby the print file includes a plurality of the identified second ones of the predefined microstructures in the second region.

13. The method of claim 12, wherein the region and the second region mate at a boundary region and wherein the identifying step comprises selecting the identified one and second identified one of the predefined microstructures to provide compatible outer surfaces for adjoining ones of the microstructures in the boundary region.

14. The method of claim 8, further comprising controlling the 3D printer using the print file to layer-by-layer print a 3D object including a plurality of the identified one of the predefined microstructures.

15. The method of claim 8, further comprising generating the 3D model of the object by receiving user input defining at least one of the region, the material parameter, and the value of the material parameter.

16. A 3D printer, comprising:
a print head with a print nozzle through which a print material is output onto a build plate to form a 3D object; and
a print controller, during printing of the 3D object, defining print locations for the print nozzle in each of a plurality of print layers defined in a digital print model of the 3D object, wherein the digital print model includes a region associated with a range of values for a material parameter and wherein the region is defined by a plurality of tiled microstructures having a geometric shape.

17. The 3D printer of claim 16, wherein the digital print model includes a second region associated with a second range of values for the material parameter differing from the range of values and wherein the second region is defined by a plurality of tiled microstructures having a second geometric shape.

18. The 3D printer of claim 16, wherein the printed 3D object comprises a plurality of the tiled microstructures formed of the print material and wherein at least a portion of the printed 3D object has a value for the material parameter falling in the range of values of the material parameter.

19. The 3D printer of claim 16, wherein the print material comprises a spool of filament of a plastic and wherein the plurality of tile microstructures provide a value of the material parameter in the range of values when formed of the plastic.

20. The 3D printer of claim 19, wherein the material parameter is elastic deformation.
